(19) United States
(12) Patent Application Publication
(10) Pub. No.: US 2025/0176085 A1
(43) Pub. Date: May 29, 2025

(54) CIRCUITRY TO CONTROL LIGHT EMITTING DIODES

(71) Applicant: TEXAS INSTRUMENTS INCORPORATED, DALLAS, TX (US)

(72) Inventors: Xiaoxiao XU, HANGZHOU (CN); Chih Pu YEH, SHANGHAI (CN)

(21) Appl. No.: 18/518,847

(22) Filed: Nov. 24, 2023

(51) Int. Cl. H05B 45/59; H05B 45/44

(52) U.S. Cl. CPC H05B 45/59; H05B 45/44

(57) ABSTRACT

In a described example, a circuit includes a plurality of line switches, each having a line input terminal, a line terminal and a line control terminal. Each of the line input terminals is coupled to a light emitting diode (LED) voltage terminal and each line terminal is coupled to a respective LED line terminal of a plurality of LED line terminals. A discharge circuit has a plurality of discharge inputs, in which each discharge input is a coupled to a respective line terminal. The discharge circuit includes a plurality of discharge switches, each having a discharge input terminal, a discharge output terminal and a discharge control terminal, in which each discharge input terminal is coupled to a respective LED line terminal. The discharge circuit also includes a current sink circuit coupled between each discharge output terminal and a ground terminal.

### TECHNICAL FIELD

This description relates to circuits to control light emitting diodes, such as to reduce ghosting.

### BACKGROUND

Light emitting diodes (LEDs) are used for a variety of purposes. For example, LEDs are used as light sources for displays, light sources for automobiles, and as light sources for other illumination. In some examples, a display includes a plurality of LED modules, in which respective modules include LEDs and LED drivers. An LED driver is an electrical circuit configured to drive LEDs and provide illumination responsive to a switching operation of one or more switch devices. In some circumstances, parasitic (e.g., stray) capacitances of associated circuitry can store energy that can result in faint illumination or “ghosting” of the intended OFF LEDs.

### SUMMARY

In a described example, a circuit includes a circuit includes a plurality of line switches, each having a line input terminal, a line terminal and a line control terminal. Each of the line input terminals is coupled to a light emitting diode (LED) voltage terminal and each line terminal is coupled to a respective LED line terminal of a plurality of LED line terminals. A discharge circuit has a plurality of discharge inputs, in which each discharge input is a coupled to a respective line terminal. The discharge circuit includes a plurality of discharge switches, each having a discharge input terminal, a discharge output terminal and a discharge control terminal, in which each discharge input terminal is coupled to a respective LED line terminal. The discharge circuit also includes a current sink circuit coupled between each discharge output terminal and a ground terminal.

In another described example, a circuit includes a switch network configured to couple a light emitting diode (LED) voltage terminal to a respective LED line terminal of a plurality of LED line terminals responsive to a respective switch control signal. A discharge circuit is configured to discharge stored energy associated with a given LED line terminal during a line switch time interval responsive to a respective line switch being turned off to disconnect the respective LED voltage terminal from the given LED line terminal. The line switch time interval can represent a time interval between the given LED line terminal being turned off and a next LED line terminal being turned on. A pre-charge circuit is configured to provide a pre-charge voltage to one or more respective channel output terminals responsive to the one or more respective channel output terminals being turned off.

In a further described example, a system includes a controller configured to provide channel control signals to turn on or off respective channels. A current sink circuit is configured to apply a drive current to one or more channel output terminals responsive to the channel control signals. A switch circuit is configured to couple an LED voltage terminal to a respective line terminal responsive to line switch control signals. A discharge circuit is configured to discharge stored energy associated with a given LED line terminal responsive to the switch circuit being controlled to disconnect a respective LED voltage terminal from the given LED line terminal. An LED matrix having a plurality of line inputs and a plurality of line outputs, in which each of the line inputs are coupled to a respective one of the line terminals and each of the line outputs is coupled to a respective one of the channel output terminals.

### BRIEF DESCRIPTION OF THE DRAWINGS

FIG. 1 illustrates an example circuit that includes a discharge circuit.

FIG. 2 is a signal diagram showing example waveforms for the circuit of FIG. 1.

FIG. 3 illustrates an example circuit that includes a pre-charge circuit.

FIG. 4 is a signal diagram showing example waveforms for the circuit of FIG. 3.

FIG. 5 illustrates an example circuit that includes a discharge circuit and a pre-charge circuit.

FIG. 6 is a signal diagram showing example waveforms for the circuit of FIG. 5.

FIGS. 7 and 8 are plots showing simulated signals for the circuit of FIG. 5.

FIG. 9 is a block diagram showing an example LED system.

FIG. 10 is a block diagram showing another example LED system.

### DETAILED DESCRIPTION

This description relates to circuits to control light emitting diodes (LEDs), such as to reduce ghosting. The circuit can be configured to reduce or eliminate ghosting by LEDs in an LED matrix, wherein an LED matrix may include, for example, rows and columns of LEDs. Examples of LED matrices include displays such as an LED panel or a backlight display. The circuit can be configured to reduce the ghosting by discharging and/or pre-charging parasitic (e.g., stray) capacitance that can exist in lines and/or channels of the LED matrix. The approach described herein can be used to reduce or eliminate ghosting for common anode, common cathode or other LED matrix topologies.

As an example, a circuit includes a plurality of line switches and a discharge circuit. The circuit can be implemented as an LED driver, such as including one or more of an integrated circuit, system on chip, and/or a printed circuit board. Each of the line switches has a line input terminal, a line terminal and a line control terminal. The line input terminal of each of the line switches can be coupled to a light emitting diode (LED) voltage terminal, which can be coupled to an LED reference voltage. The line terminal of each respective switch is coupled to a respective LED line terminal of a plurality of LED line terminals. A first LED terminal (e.g., anode or cathode) of each LED in a given line (e.g., a row or column) of the matrix thus can be coupled to a respective one of the LED line terminals. A second LED terminal of each LED in a given channel (e.g., a column or row) of the matrix can be coupled to a respective channel output terminal of a plurality of channel output terminals.

The discharge circuit has a plurality of discharge inputs, in which each discharge input is coupled to a respective line terminal (e.g., for a separate row or column of the LED matrix). For example, the discharge circuit includes a plurality of discharge switches and a current sink circuit. Each discharge switch has a discharge input terminal, a discharge output terminal and a discharge control terminal, in which each discharge input terminal is coupled to a respective LED line terminal. The current sink circuit is coupled between the discharge output terminal of each respective discharge switch and a ground terminal.

As described herein, each LED line terminal can have an associated parasitic line capacitance that is adapted to store energy (e.g., charge) based on voltage and/or current provided to the respective line during operation thereof. The stored energy can result in ghosting of one or more LEDs coupled to the line where such energy is stored. The discharge circuit is thus configured to discharge stored energy associated with a given LED line terminal responsive to a given line switch being controlled (e.g., turned off) to disconnect the LED voltage terminal from the given LED line terminal. The discharge circuit can thus activate (e.g., turn on or close) a respective discharge switch during a line switch time interval that represents a period of time between when the given LED line terminal is turned off (e.g., disconnected from the LED voltage terminal) and a next LED line terminal is turned on (e.g., coupled to the LED voltage terminal).

In addition to parasitic capacitance at line terminals, there can also be channel parasitic capacitances that can also cause ghosting for LEDs coupled to respective channels. Accordingly, the circuit can also include a pre-charge circuit. The pre-charge circuit can include a plurality of pre-charge switches coupled between an input voltage terminal and a respective channel output terminal of a number of channel output terminals. The LED matrix thus can include a like number of LED channels, each of which can be coupled to a respective one of the channel output terminals. The pre-charge circuit is configured to apply a pre-charge voltage to one or more channel output terminals responsive to the one or more channels being turned off.

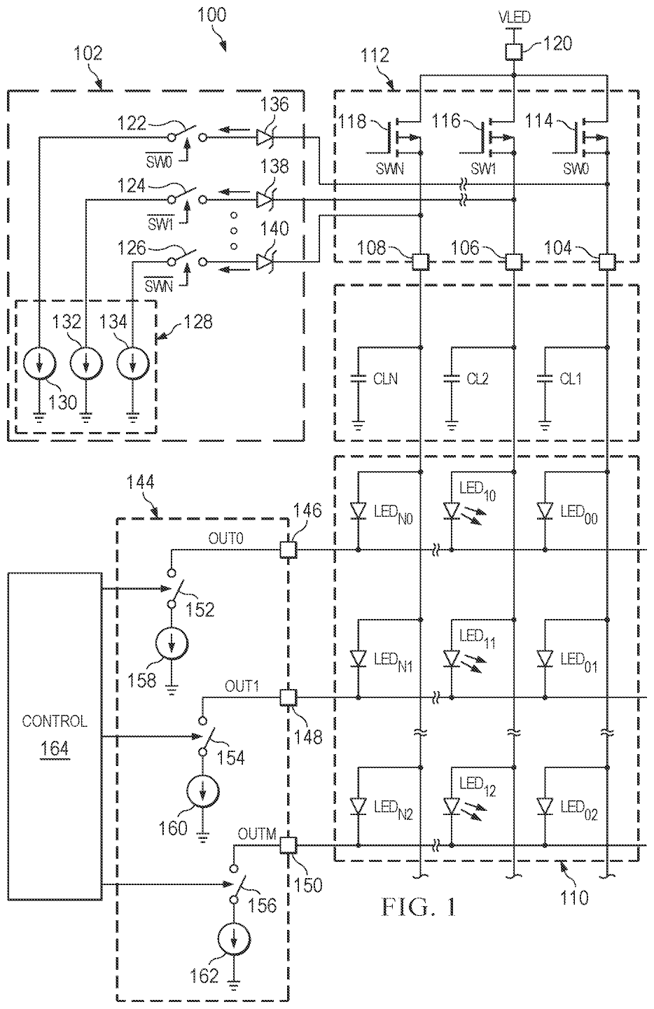

FIG. 1 illustrates an example circuit 100 that includes a discharge circuit 102. The discharge circuit 102 has a plurality of discharge inputs, in which each discharge input is coupled to a respective line terminal 104, 106 and 108 of a plurality of N line terminals (where N is positive integer denoting the number of LED line outputs). Each line terminal 104, 106, 108 is adapted to be coupled to a respective line of an LED matrix, shown at 110. The LED matrix 110 can include any number of lines and channels, which may be referred to as rows or columns of the matrix depending on the orientation of the matrix without distinction.

The circuit 100 includes a switch network 112 that includes a plurality of line switches 114, 116 and 118, in which each switch has a line input terminal coupled to an LED voltage terminal 120. The LED voltage terminal 120 can be coupled to an LED voltage supply and receive a respective voltage, shown as VLED. In one example, such as shown in FIG. 1, the line switches 114, 116 and 118 are P-channel metal oxide semiconductor field effect transistors (PMOS transistors). In other examples, the line switches 114, 116 and 118 can be implemented as other types of switch devices, such as N-channel metal oxide semiconductor field effect transistors (NMOS transistors), bipolar junction transistors, relays or the like. In the PMOS example, each line switch 114, 116 and 118 includes a first current terminal (source) coupled to the LED voltage terminal 120 and a second current terminal (drain) coupled to the respective line terminal 104 106 and 108.

A parasitic line capacitance, shown at CL1, CL2 and CLN, can be associated with each line. For example, each parasitic line capacitance CL1, CL2 and CLN can store energy (charge) responsive to the respective line terminal 104, 106 and 108 being coupled to VLED through the respective switch to turn on the respective line. In the absence of discharge circuit 102, when a respective line is turned off, parasitic line capacitance CL1, CL2 or CLN can cause ghosting of one or more LEDs on the line based on the stored energy.

The discharge circuit 102 is configured to discharge the stored energy associated with a given line terminal during a line switch time interval responsive to a respective line switch 114, 116, 118 being turned off (e.g., by controlling the line switch to disconnect the respective line terminal 104, 106 and 108 from the LED voltage terminal 120). In the example of FIG. 1, the discharge circuit 102 includes a plurality of discharge switches 122, 124 and 126. Each discharge switch 122, 124 and 126 has a discharge input terminal coupled to a respective LED line terminal 104, 106 and 108. Each discharge switch 122, 124 and 126 has a discharge output terminal and a discharge control terminal. A current circuit 128 is coupled between each discharge output terminal and a ground terminal. In an example, the current circuit 128 includes a plurality of current sources 130, 132 and 134, in which each respective current source is coupled between a respective discharge output terminal of a respective switch 122, 124 and 126 and the ground terminal. Thus, each current source 130, 132 and 134 is configured to sink a corresponding discharge current from a respective line responsive to the switch 122, 124 or 126 being closed. Other types and configurations of current source circuits can be used in other examples to provide current to discharge energy from the respective lines of the LED matrix.

In the example of FIG. 1, the discharge circuit 102 includes a plurality of Zener diodes 136, 138 and 140, in which each Zener diode is coupled between a discharge input terminal of a respective discharge switch 122, 124 and 126 and a respective LED line terminal 104, 106 and 108. Each of the Zener diodes 136, 138 and 140 can be configured to set a discharge voltage at the respective LED line terminal 104, 106 and 108. A different Zener diode can be used to adapt the discharge voltage to accommodate different types of LEDs in the matrix 110 and/or the number of LEDs in series for each line. In some examples, the Zener diodes 136 138 and 140 can be external to the integrated circuit (IC) implementing the LED driver circuitry and discharge circuit 102 (e.g., the Zener diodes can be mounted to a circuit board), such as to further enhance the configurability of the discharge voltage for a given application and use environment. By setting the voltage to a prescribed discharged voltage, voltage reversal across the LEDs can be reduced (or prevented) during discharge events.

As described herein, the discharge circuit is configured to discharge stored energy associated with a given LED line terminal interval responsive to a respective line switch 114, 116 or 118 being controlled (e.g., turned off) to disconnect the LED voltage terminal from the respective LED line terminal 104, 106 or 108. The discharge switches can be activated during a line switch time interval that represents a time interval between the given LED line terminal being turned off and a next LED line terminal being turned on. For example, a controller is configured to turn each of the line switches on and off according to a duty cycle and line period as well as impose a line switch time interval between when a given switch is turned off and the next switch is turned on. The duty cycle, line period, line switch time interval and other operating parameters for each line switch 114, 116 and 118 can vary depending on the number of lines and other operating parameters of the circuit 100.

The circuit 100 also includes a current drive circuit (also referred to as a current driver) 144 configured to provide drive current to each of a plurality of M channel output terminals 146, 148 and 150 (where M is a positive integer denoting the number of LED channel outputs). For example, the current driver 144 includes a switch 152, 154, 156 and a current source 158, 160, 162 coupled between each respective channel output terminal 146, 148, 150 and the ground terminal. A control circuit 164 can be coupled to a control input of each switch 152, 154, 156 and configured to provide a switch control signal to turn on or off each channel by connecting or disconnecting the respective current source from each channel output. For example, the control circuit 164 is configured to provide a pulse-width modulated (PWM) switch control signal to a control input of each respective switch 152, 154, 156. Each current source 158, 160, 162 is thus configured to provide driving current to turn on a respective one of the channel output terminals based on the switch control signal. The circuit 100 can be implemented as an IC or a system on a chip (SOC). For example, the discharge circuit 102, line switch network 112 and current driver 144 are implemented as part of an LED driver IC. In some examples, the Zener diodes can be implemented as part of circuitry external to the LED driver IC.

The LED matrix 110 can be an LED panel or other form of LED display (e.g., a backlight). The LED matrix 110 includes a plurality of line inputs and a plurality of channel outputs. Each of the line inputs is coupled to a respective line terminal 104, 106 and 108. Each of the matrix channel output terminals is coupled to a respective one of the channel output terminals 146, 148 and 150. Each line and channel of the LED includes a number of LEDs 166, in which each LED has an anode coupled to a line terminal and a cathode coupled to a channel terminal. Other configurations of LEDs 166 can be used in other examples.

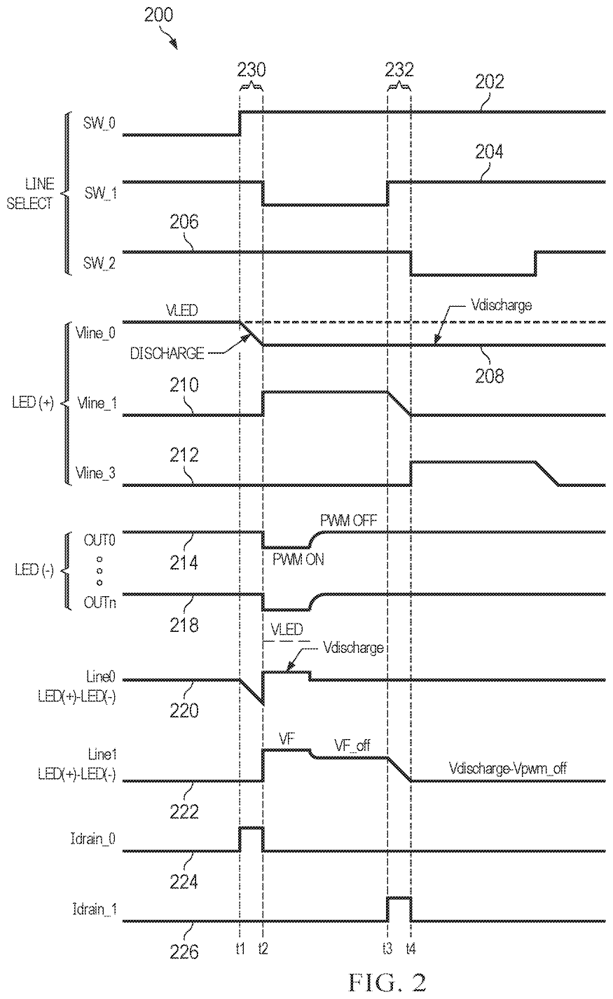

FIG. 2 is a signal diagram 200 showing example waveforms for the circuit 100 of FIG. 1. Accordingly, the description of FIG. 2 also refers to FIG. 1. Line select signals 202, 204 and 206 represent signals applied to the control inputs (gates) of switches (PMOS transistors) 114, 116 and 118. Signals 208, 210 and 212 represent line voltage signals at the respective line terminals 104, 106 and 108, which are at respective anodes of the LEDs for each line. The diagram also shows signals 214 and 218 at respective channel outputs 146, 148 and 150. Also shown are signals 220 and 222 representative of a voltage drop across LEDs, namely a difference between signals 208 and 214 and a difference between signals 210 and the signal at output channel terminal 148 (not shown in FIG. 2). The drain currents for PMOS transistors 114 and 116 are further shown at 224 and 226, respectively.

As shown in FIG. 2, the switch (PMOS transistor) 114 is turned off at time t1, which is the beginning of a corresponding line switch time interval 230 that ends at time t2. In response to the switch 114 being turned off the voltage at line terminal 104 discharges from VLED to VDISCHARGE during the line switch time interval (from time t1 to time t2) 230. As described herein, the voltage VDISCHARGE can be set based on the Zener diode 136 and is less than VLED. Further, the rate of discharge and associated discharge time during the line switch time interval 230 can be controlled based on the discharge current (e.g., provided by respective current sources 130, 132, 134), such as by setting registers to set the discharge current. In some examples, the voltage 208 (at terminal 104) can remain at VDISCHARGE until the next cycle when the switch 114 is turned on. As also shown, the voltage potential across LEDs of line 0 (e.g., coupled to terminal 104) decreases during the line switch time interval 230 between t1 and t2, which turns off the LED, and then increases to the voltage VDISCHARGE for a duration based on PWM applied at switch 152 to control the channel output terminal 146. For example, the duration of VDISCHARGE is set by a register, and the minimum unit of time for the duration can depend on a clock signal. The on-time of a line can also be set by registers and when a given line is changed to off, the next line that is turned on will wait the line switch time interval before turning on.

At time t2, the next switch 116 is activated (e.g., for line 1), as shown at signals 204 going low, which causes the signal 210 to be pulled to VLED. As a result, the signal 222, which is the voltage across the LEDs, is increased to a forward voltage sufficient to turn on one or more LEDs coupled to line 1 of the LED matrix 110. At time t3 (the start of another line switch time interval 232), the signal 204 goes high and the discharge circuit is activated to discharge energy stored in parasitic line capacitance CL2 at the line terminal 106 until time t4 (the end of the line switch time interval 232). The process then repeats for each subsequent line N.

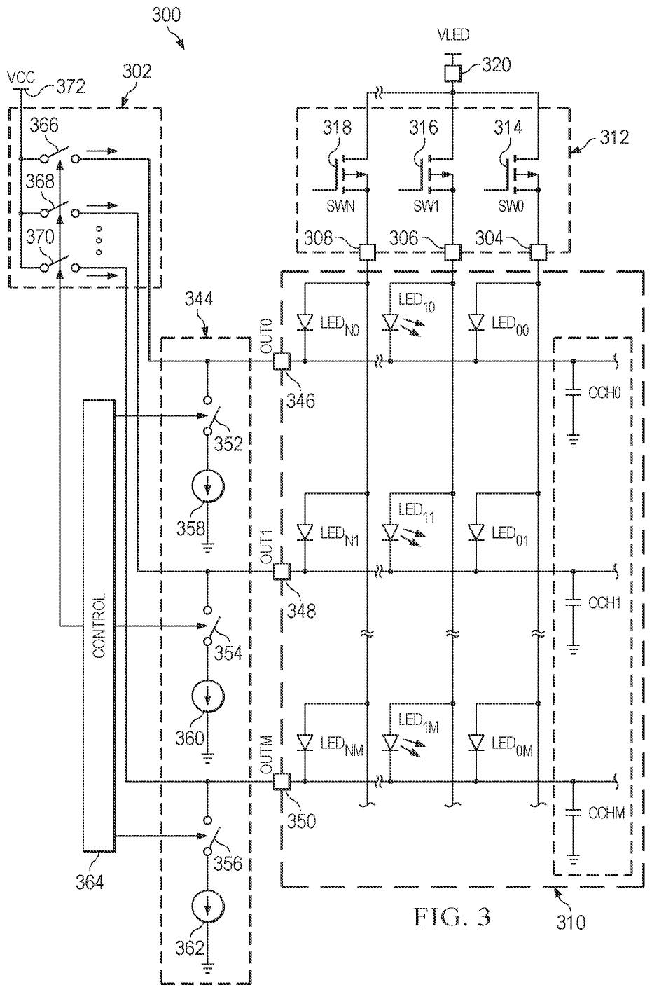

FIG. 3 illustrates an example circuit 300 that includes a pre-charge circuit 302 configured to reduce ghosting of LEDs of an LED matrix 310. The circuit 300 includes a switch network 312 having one or more inputs coupled to an LED voltage terminal 320 and outputs coupled to a number of N line terminals 304, 306 and 308. The LED voltage terminal 320 can be coupled to an LED voltage supply and receive a corresponding voltage VLED. Each line terminal 104, 106, 108 is adapted to be coupled to a respective line of an LED matrix 310 (e.g., a panel, a backlight or other configuration).

The switch network 312 includes a plurality of line switches 314, 316 and 318, in which each switch has a line input terminal coupled to an LED voltage terminal 320. In one example, such as shown in FIG. 3, the line switches 314, 316 and 318 are P-channel metal oxide semiconductor field effect transistors (PMOS transistors). In other examples, the line switches 314, 316 and 318 can be implemented as other types of switch devices, such as N-channel metal oxide semiconductor field effect transistors (NMOS transistors), bipolar junction transistors, relays or the like. In the PMOS example, each line switch 314, 316 and 318 includes a first current terminal (source) coupled to the LED voltage terminal 320 and a second current terminal (drain) coupled to the respective line terminal 304 306 and 308.

The circuit 300 also includes a current driver 344 configured to provide drive current to each of a plurality of M channel output terminals 346, 348 and 350. For example, the current driver 344 includes a switch 352, 354, 356 and a current source 358, 360, 362 coupled in series between each respective channel output terminal 346, 348,150 and the ground terminal. A control circuit 364 can be coupled to a control input of each switch 352, 354, 356 and configured to provide a switch control signal to turn on or off each channel by connecting or disconnecting the respective current source from each channel output. For example, the control circuit 364 is configured to provide a pulse-width modulated (PWM) switch control signal to a control input of each respective switch 352, 354, 356. Each current source 358, 360, 362 is thus configured to provide driving current to turn on a respective one of the channel output terminals based on the switch control signal.

In the example of FIG. 3, the circuit 300 illustrates parasitic channel capacitance coupled to each channel, shown at CCH0, CCH1 and CCHM coupled between a respective channel output terminal and the ground terminal. As described herein, the pre-charge circuit 302 is configured to apply a pre-charge voltage to one or more channel output terminals 346, 348, 350 responsive to the one or more channel output terminals being turned off. In the example of FIG. 3, the pre-charge circuit 302 includes M switches 366, 368 and 370, each having a pre-charge input terminal, a pre-charge output terminal and a channel control terminal. Each pre-charge input terminal is coupled to an input voltage terminal 372 and each pre-charge output terminal is coupled to a respective channel output terminal 346, 348, 350. For example, the input voltage terminal 372 is coupled to a supply voltage to receive a DC voltage, shown as VCC. In an example, VCC is greater than VLED (e.g., VCC≈2VLED). The pre-charge circuit 302 is configured to apply a pre-charge voltage to one or more channel output terminals responsive to the one or more channel output terminals being turned off. For example, the control circuit 364 is configured to turn on one or more switches 366, 368 and 370 in response to a given driver circuit being turned off (e.g., responsive to drive switch 352, 354, 356 being open). As a result, a pre-charge voltage is applied to one or more of the channel output terminals 346, 348, 350 to inhibit (or prevent ghosting) when the channel is turned off. For example, the pre-charge voltage approximates the voltage VCC at the terminal 372 less the voltage drop across the respective one or more switches 366, 368 and 370 that are turned on.

The circuit 300 can be implemented as an IC or SOC. For example, the pre-charge circuit 302, line switch network 312 and current driver 344 are implemented as part of an LED driver IC.

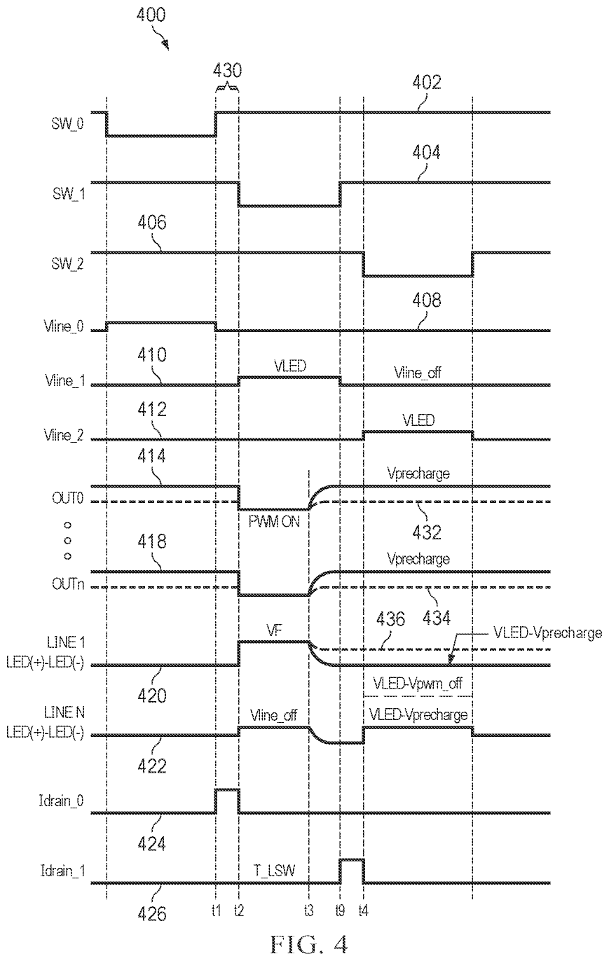

FIG. 4 is a signal diagram 400 showing example waveforms for the circuit of FIG. 3. Accordingly, the description of FIG. 4 also refers to FIG. 3. The diagram includes line select signals 402, 404 and 406 represent signals applied to the control inputs (gates) of switches (PMOS transistors) 314, 316 and 318, respectively. Signals 408, 410 and 412 represent line voltage signals at the respective line terminals 304, 306 and 308, which are at respective anodes of the LEDs for each line. The diagram also shows signals 414 and 418 at respective channel outputs 346 and 350. Also shown are signals 420 and 422 representative of a voltage drop across LEDs for respective lines 1 and N, namely a difference between signals 408 and 414 (line 1) and a difference between signals 410 and 418 (line N). The drain currents for PMOS transistors 314 and 316 are further shown at 424 and 426, respectively.

As shown in FIG. 4, the switch (PMOS transistor) 314 is turned off at time t1, which is the beginning of a corresponding line switch time interval 430 that ends at time t2. In response to the switch 314 being turned off the voltage signal 408 at line terminal 304 goes from VLED to Vline_off. In some examples, the line voltage signal 408 (at terminal 304) can remain at Vline_off until the next cycle when the switch 314 is turned on. At time t2, the line switch 316 is turned on, and the voltage signal 410 at line terminal 305 goes from Vline_off to VLED. Between times t2 and t3, one or more of the output channels are turned on (e.g., collectively or sequentially) during a channel on-time interval responsive to controlling one or more of the channel switches 352, 354, 356. For example, the control circuit 364 provides PWM control signals to turn on one or more of the switches 352, 354, 356, which pulls the voltage signals 414 and 414 at each channel output terminal 346, 348, 350 that is turned-on to approximately the voltage of the ground terminal (e.g., about 0 V). At time t2, the voltage signal 420 is sufficient to forward bias the LEDs on line 1 that are coupled to respective channels that are also turned on. At time t3, one or more channels (e.g., up to all channels) are turned off, such as by terminating the PWM control signal such that the current sources 358, 360, 362 are disconnected from the respective channel output terminals 346, 348, 350. In response to or concurrently with the one or more channels being turned off, the pre-charge circuit 302 is activated (e.g., by control circuit 364) to apply the pre-charge voltage at each respective channel output terminal 346, 348, 350 that is turned off, shown at 418 and 420. In the absence of the pre-charge voltage, the voltage signals 418 and 420 would be reduced accordingly, as shown by dashed lines 432 and 434, respectively. Additionally, the pre-charge voltage applied at time t3 causes a further decrease in the voltage signals 420 and 422 based on the pre-charge voltage. As described herein, the decrease in the signals 420 based on the pre-charge voltage inhibits (or prevents) ghosting of the LEDs of line 1 that are turned off at time t3. There can be a similar decrease in the voltage signals for one or more other lines based on the pre-charge voltage after the next line switch interval between times t4 and t5, as shown in signal 422 at time t5. The process can continue by repeating the process and applying pre-charge voltages for respective channels.

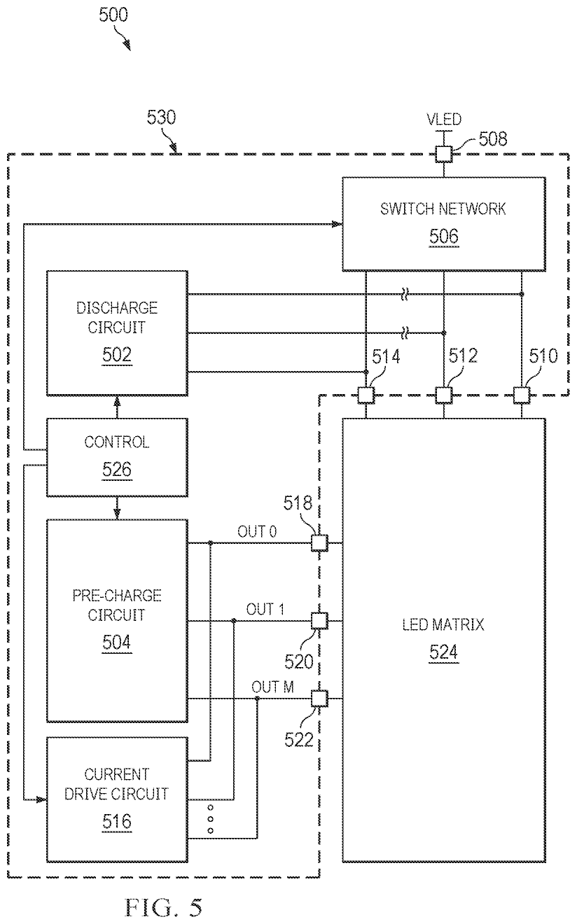

FIG. 5 illustrates an example circuit 500 that includes a both discharge circuit 502 and a pre-charge circuit 504. For example, the discharge circuit 502 can be implemented as an instance of the discharge circuit 102, and the pre-charge circuit 504 can be implemented as an instance of the pre-charge circuit 302. The circuit 500 thus is configured to implement both discharge and pre-charge functions to reduce ghosting of LEDs as described herein.

The circuit 500 can also include a switch network 506 coupled between an LED voltage terminal 508 and each of a number of respective line terminals 510, 512 and 514. The switch network 506 can include a plurality of line switches (e.g., PMOS or other transistors), such as described herein. For example, the switch network 506 is implemented as an instance of the switch network 112 or 312. Other switch network configurations can also be used. The circuit 500 also includes a current driver circuit 516 configured to provide drive current to one or more of M channel output terminals 518, 520 and 522. For example, the current driver circuit 516 is implemented as an instance of the current driver circuit 144 or 344 described herein. Other configurations of current drivers can be used.

The circuit 500 also includes an LED matrix 524 coupled to the line terminals 510, 512 and 514 and the channel output terminals 518, 520 and 522. The LED matrix thus can include up to M×N LEDs that are turned on and off based on control signals provided by a control circuit 526. For example, the control circuit can be implemented as logic or a microcontroller configured to control each of the switch network 506, the discharge circuit 502, the current driver circuit 516 and the pre-charge circuit 504 for operating the LED matrix 524, such as described herein. Accordingly, the discharge circuit 502 is configured to discharge stored energy associated with a given LED line terminal 510, 512 or 514 based on a discharge control signal (e.g., provided by the control circuit 526) during a line switch time interval responsive the switch network 506 being controlled to disconnect the given LED line terminal from the LED voltage terminal 508. Also, or as an alternative, the pre-charge circuit 504 is configured to apply a pre-charge voltage to one or more channel output terminals 518, 520, 522 based on a pre-charge control signal (e.g., provided by the control circuit 526) responsive to the one or more channel output terminals being turned off (e.g., by current drive circuit 516). The circuit 500 can also include an LED driver IC 530. The IC 530 can include any part of or all of the switch network 506, the discharge circuit 502, the control circuit 526, the pre-charge circuit 504 and the current drive circuit 516.

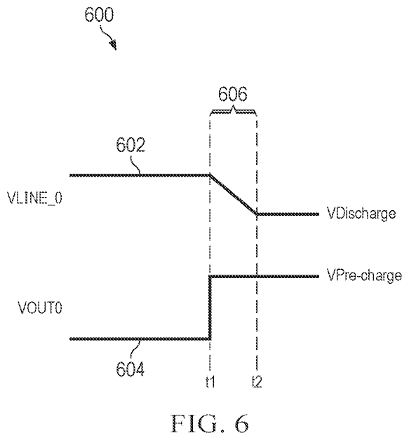

FIG. 6 is a signal diagram 600 showing portions of example waveforms 602 and 604 for the circuit of FIG. 5. Accordingly, the description of FIG. 6 also refers to FIG. 5. For example, the waveform 602 is representative of the voltage at line terminal 510 (VLINE_0), such as can correspond to the voltage at a drain of PMOS (see FIGS. 1 and 3) and at an anode of LEDs coupled to line terminal 510. As shown, the voltage 602 discharges from approximately VLED to VDischarge during a line switch time interval, shown at 606, between times t1 and t2. The other waveform is representative of the voltage at channel output terminal 518 (VOUT0) responsive to the channel being turned off at time t1. As shown in FIG. 6, the voltage 608 at the channel output terminal 518 goes from approximately ground voltage (e.g., 0 V) to VPre-charge at time t1 when the respective channel is turned off. As described herein, the discharge circuit 502 and the pre-charge circuit 504 can further be configured to control peak power consumption and adjust the potential difference between VDischarge and VPre-charge to avoid applying a reverse voltage across respective LEDs of the LED matrix 524.

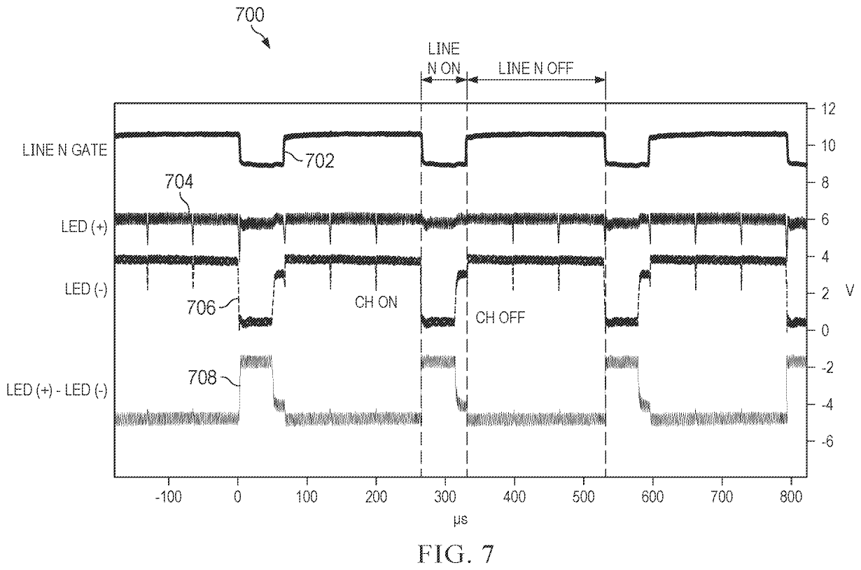

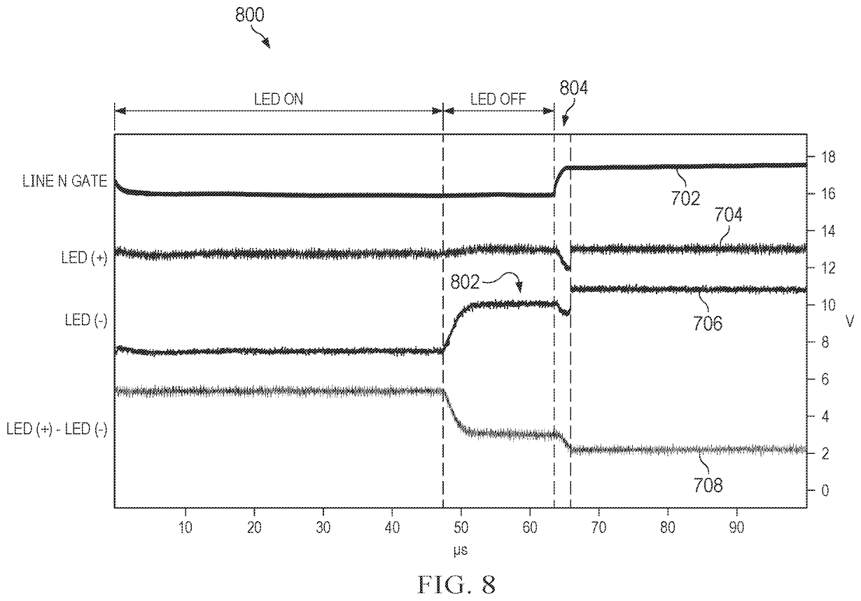

FIGS. 7 and 8 are plots 700 and 800 showing simulated signals, such as can be provided for the circuit of FIG. 5. Accordingly, the description of FIGS. 7 and 8 also refer to FIG. 5 The plot 700 of FIG. 7 shows switch select signal 702, such as can be provided to a gate of a given PMOS transistors of the switch network 506. The plot 700 also shows voltage signals 407, 706 and 708. The signal 704 shows the voltage at a line terminal for the given line (LED+) and the voltage signal 706 at a respective channel output (LED−). Thus, the signal 708 shows a potential across the LED, which is the difference between the signals 704 and 706 (e.g., LED+-LED−). The plot 800 shows an enlarged view of the signals 702, 704, 706 and 708 from FIG. 7, including showing a pre-charge voltage 802 that is provided when the respective channel is turned off. The voltage signal 704 also exhibits a discharge during a line switch time interval 804. The pre-charge voltage 802 and discharge at 804 thus can work together to further inhibit ghosting, as described herein.

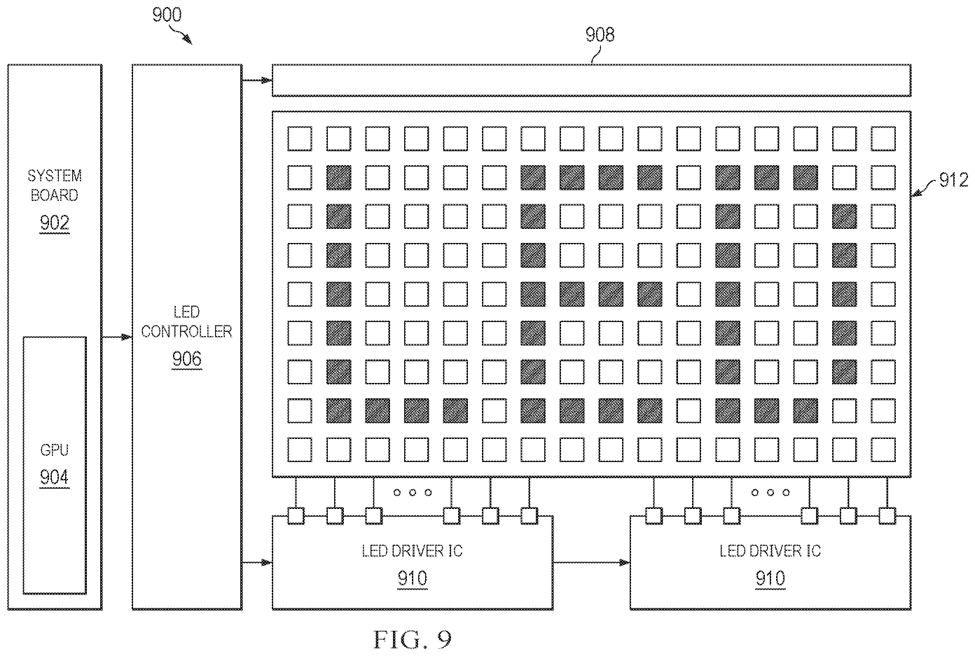

FIG. 9 is a block diagram showing an example LED system 900 that includes an LED matrix implemented as a backlight unit 912. The system 900 also includes a system board 902 that has a graphics processing unit (GPU) 904 that is coupled to an LED controller 906, which can be implemented as a circuit board or an SOC. The LED controller 906 is coupled to an LCD or other display panel 908 and to an arrangement of one or more LED driver ICs 910. The LED controller 906 can be configured to provide a video stream to the display panel 908 and provide backlight control signal to an input of one of the LED driver ICs 910. Each of the LED driver ICs 910 can have outputs coupled to respective inputs of the backlight unit. Each of the LED driver ICs 910 can include pre-charge circuit and/or discharge circuit, as described herein (see, e.g., FIGS. 1-8) to inhibit ghosting of LEDs in the backlight unit 912.

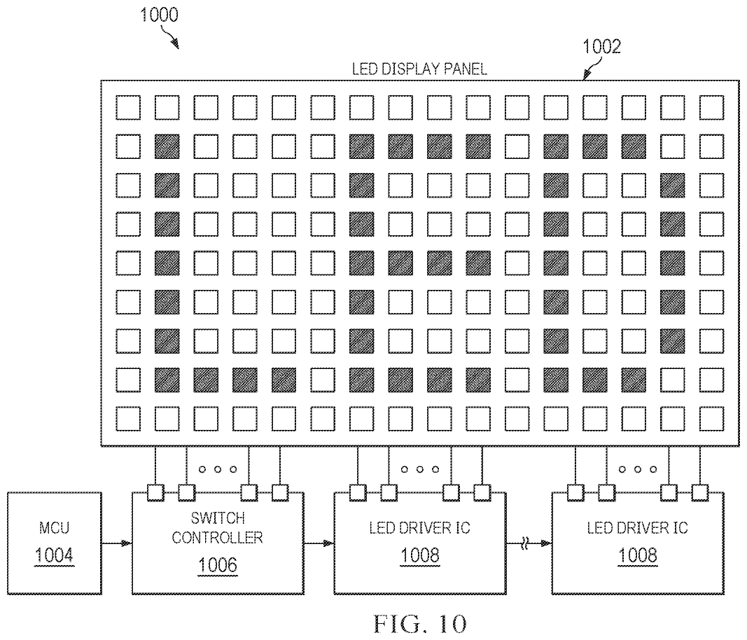

FIG. 10 is a block diagram showing another example LED system 1000 that includes an LED matrix implemented as an LED display panel 1002. The system also includes a microcontroller unit (MCU) 1004, a switch controller 1006 and an arrangement of LED driver ICs 1008. Each of the LED driver ICs 1008 can have outputs coupled to respective inputs of the display panel 1002. As described herein, each of the LED driver ICs 1008 can further include a pre-charge circuit and/or a discharge circuit (see, e.g., FIGS. 1-8) to inhibit ghosting of LEDs in the display panel 1002.

In view of the foregoing, the circuits and systems described herein can include a discharge circuit and/or pre-charge circuit to inhibit (or prevent) ghosting of LEDs. The discharge circuit can be configured to operate during a line switch time interval. Also, the discharge voltage, current and time can be configurable. For example, the discharge voltage can be adjusted by selecting or configuring the types and number of Zener diodes (e.g., configured by registers or other circuitry). The approach described herein can be implemented in existing systems with simple hardware and/or software, and with little extra power consumption. As described herein, the discharge and pre-charge circuits can cooperate to avoid reverse LED voltages during operation. The de-ghosting circuitry (e.g., pre-charge and/or discharge circuits) described herein further can be implemented effectively even in cases where VLED fluctuations. The pre-charge and/or discharge circuits further can be implemented to achieve high contrast ratio as well as in extreme environmental conditions, such as high temperature and high humidity environments.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

The recitation “based on” means “based at least in part on.” Therefore, if X is based on Y, X may be a function of Y and any number of other factors.

Modifications are possible in the described embodiments, and other embodiments are possible, within the scope of the claims.

What is claimed is:

1. A circuit comprising:
a plurality of line switches, each having a line input terminal, a line terminal and a line control terminal, in which each of the line input terminals is coupled to a light emitting diode (LED) voltage terminal and each line terminal is coupled to a respective LED line terminal of a plurality of LED line terminals;
a discharge circuit having a plurality of discharge inputs, in which each discharge input is a coupled to a respective line terminal, the discharge circuit comprising:
a plurality of discharge switches, each having a discharge input terminal, a discharge output terminal and a discharge control terminal, in which each discharge input terminal is coupled to a respective LED line terminal; and
a current sink circuit coupled between each discharge output terminal and a ground terminal.

2. The circuit of claim 1, further comprising a plurality of Zener diodes, in which each Zener diode is coupled between a respective discharge input terminal and a respective LED line terminal.

3. The circuit of claim 2, wherein each of the Zener diodes is configured to set a discharge voltage at the respective LED line terminal.

4. The circuit of claim 2, wherein the current sink circuit includes a plurality of current sources, in which each respective current source is coupled between a respective discharge output terminal and the ground terminal.

5. The circuit of claim 1, wherein the discharge circuit is configured to discharge stored energy associated with a given LED line terminal during a line switch time interval responsive to a respective line switch being controlled to disconnect the LED voltage terminal from the given LED line terminal, in which the line switch time interval represents a time interval between the given LED line terminal being turned off and a next LED line terminal being turned on.

6. The circuit of claim 1, further comprising a pre-charge circuit that includes a plurality of pre-charge switches, each having a pre-charge input terminal, a pre-charge output terminal and a channel control terminal, in which each pre-charge input terminal is coupled to an input voltage terminal and each pre-charge output terminal is coupled to a respective channel output terminal of a plurality of channel output terminals.

7. The circuit of claim 6, wherein the pre-charge circuit is configured to apply a pre-charge voltage to one or more channel output terminals responsive to the one or more channel output terminals being turned off.

8. The circuit of claim 6, further comprising a current driver for each LED channel, in which each current driver is configured to provide driving current to turn on a respective one of the channel output terminals.

9. The circuit of claim 6, further comprising an LED matrix having a plurality of line inputs and a plurality of channel outputs, in which each of the line inputs is coupled to a respective line terminal and each of the channel output terminals is coupled to a respective one of the channel outputs.

10. The circuit of claim 6 implemented as an integrated circuit.

11. A circuit comprising:
a switch network configured to couple a light emitting diode (LED) voltage terminal to a respective LED line terminal of a plurality of LED line terminals responsive to a respective switch control signal;
a discharge circuit configured to discharge stored energy associated with a given LED line terminal during a line switch time interval responsive to a respective line switch being turned off to disconnect the respective LED voltage terminal from the given LED line terminal, in which the line switch time interval represents a time interval between the given LED line terminal being turned off and a next LED line terminal being turned on; and
a pre-charge circuit configured to provide a pre-charge voltage to one or more respective channel output terminals responsive to the one or more respective channel output terminals being turned off.

12. The circuit of claim 11, wherein the discharge circuit includes:
a plurality of discharge switches, in which each discharge switch is coupled between a respective LED line terminal and a current circuit and configured to turn on and couple a respective line terminal to the current circuit responsive to the respective LED line terminal being turned off.

13. The circuit of claim 12, wherein the current circuit includes a respective current source coupled between each discharge switch and a ground terminal, in which each current source is configured to sink current from a respective LED line terminal responsive to the respective discharge switch being turned on.

14. The circuit of claim 12, wherein the discharge circuit further includes a plurality of Zener diodes, in which each of the Zener diodes is configured to set a respective discharge voltage at the respective LED line terminal responsive to the discharge switch being turned on to couple the respective LED line terminal to the LED voltage terminal.

15. The circuit of claim 12, wherein each discharge switch is configured to turn off and disconnect the respective line terminal and the current circuit responsive to the respective LED line terminal being turned on.

16. The circuit of claim 11, wherein the pre-charge circuit includes a plurality of pre-charge switches, in which each of the pre-charge switches is configured to couple a respective one of the channel output terminals to a pre-charge voltage terminal responsive to a respective one of the channel output terminals being turned off and the pre-charge voltage terminal is configured to supply the pre-charge voltage.

17. The circuit of claim 16, further comprising a current driver for each LED channel, in which each current driver is configured to provide driving current to turn on a respective one of the channel output terminals.

18. The circuit of claim 11, further comprising an LED matrix having a plurality of line inputs and a plurality of channel outputs, in which each of the line inputs is coupled to a respective line terminal and each of the channel output terminals is coupled to a respective channel output terminal.

19. The circuit of claim 11 implemented as an integrated circuit.

20. A system comprising:
a controller configured to provide channel control signals to turn on or off respective channels;
a current sink circuit configured to apply a drive current to one or more channel output terminals responsive to the channel control signals;
a switch circuit configured to couple an LED voltage terminal to a respective line terminal responsive to line switch control signals;
a discharge circuit configured to discharge stored energy associated with a given LED line terminal responsive to the switch circuit being controlled to disconnect a respective LED voltage terminal from the given LED line terminal; and
an LED matrix having a plurality of line inputs and a plurality of line outputs, in which each of the line inputs are coupled to a respective one of the line terminals and each of the line outputs is coupled to a respective one of the channel output terminals.

21. The system of claim 20, wherein the LED matrix includes an array of LEDs configured as one of a backlight and/or a display panel.

22. The system of claim 20, wherein the current sink circuit, the switch circuit, and the discharge circuit are implemented in a respective integrated circuit.
